(19) United States
(12) Patent Application Publication
(10) Pub. No.: US 2019/0178704 A1
(43) Pub. Date: Jun. 13, 2019

(54) TYPE OF BODY FAT SCALE ON A FOOT STOOL OF CLOSESTOOL

(71) Applicant: JOHNLUI.COM, CENTRAL (HK)

(72) Inventor: CHI KWONG LUI, CENTRAL (HK)

(21) Appl. No.: 15/867,864

(22) Filed: Jan. 11, 2018

(30) Foreign Application Priority Data
Dec. 8, 2017 (CN) 201711296495.7

(51) Int. Cl. G01G 19/44; A47C 16/02

(52) U.S. Cl. CPC G01G 19/44; A47C 16/02

(57) ABSTRACT

A body fat scale on the foot stool of closestool includes the integrated foot stool of closestool and the control board of body fat scale inserted in the foot stool of closestool. There is an ITO coating on the top surface of the foot stool of closestool. The ITO coating is set on a glassy layer through electroplating, this glassy layer is installed over the foot stool of closestool, there are many pressure sensors between the glassy layer and the top surface of the foot stool of closestool, there are non-slip mats on the back surface of the four corners at the lower end of the foot stool of closestool. The ITO coating and the pressure sensors are electrically connected with the control board of the body fat scale.

This application claims priority for China patent application no. 201711296495.7 filed on Dec. 8, 2017, the content of which is incorporated by reference in its entirety.

### BACKGROUND OF THE INVENTION

### Field of the Invention

The invention relates to the articles for daily use and it is a type of body fat scale on the foot stool of closestool.

### Description of the Related Art

As the improvement of people's living quality, smart household is also popularized, the people's requirements on the life quality is increasingly high and the electronic instruments used for testing the physical condition, e.g., the scales which can measure the weight and the users' body fat are applied widely.

The electronic body fat scales on the market at present consist of bearing body, supporting legs, foot pole plate, weighing sensor, process control block and LCD display, the supporting legs, weighing sensor, process control block and LCD display are respectively installed and fixed on the back face of the bearing body, the foot pole plate is installed on the front face of the bearing body, the bearing body is generally made into plastic, glass, metal plate, face side or bamboo face structure, the foot pole plate is connected with the process control block through the wire material of foot pole plate, in order to connect the wire of foot pole plate, it needs to open a hole on the nearing body, so that the wire material of foot pole plate can be turned to the back face of the bearing body from the front face, therefore, the holes need to be drilled on the plate materials such as the glass. But there are limits on the diameter of holes drilled on the plate materials, the hole diameter is generally not less than 10 mm, meanwhile, drilling holes on the plate materials can increase the processing cost, the defect rate during production will be higher and it can partially affect the intensity of the electronic body fat scale.

At present, there is no tool which can be input health data regularly, i.e., there is no need to wear bracelets or instrument, when putting the feet on the stool for sensoring input during using the closestool, the application program of the mobile terminal will start automatically, thus it is an electronic product which can obtain health data.

### SUMMARY OF THE INVENTION

In order to solve the above mentioned problems, the invention provides a type of body fat scale on the foot stool of closestool.

To achieve the above purpose, the technical solution of the invention is:

A type of body fat scale on the foot stool of closestool, it includes an integrated foot stool of closestool and the top surface inserted at the foot stool of closestool is coated with ITO coating which is set on a glassy layer through electroplating, this glassy layer is installed over the foot stool of closestool, there are many pressure sensors between the glassy layer and the top surface of the foot stool of closestool, there are non-slip mats on the back surface of the four corners at the lower end of the foot stool of closestool, and both the ITO coating and the pressure sensors are electrically connected with the control board of the body fat scale; there is a cell box electrically connected with the control board of the body fat scale, a KG/LB/ST selector switch and a button switch on the side face of the foot stool of closestool 1.

As an optimal option, the material of the foot stool of closestool is prepared with 80% PP+20% calcium carbonate.

As an optimal option, the non-slip mats are made of 100% TPE.

As an optimal option, the control board control board of the body fat scale is equipped with a bluetooth module and it can communicate with the mobile terminals through the bluetooth signals.

As an optimal option, the control board of the body fat scale body fat scale is equipped with an LED display module which is horizontally inserted in and flushes with the top surface of the foot stool of closestool.

As an optimal option, the number of the ITO coating is 10, each five is a group and they are laid according to the model of the frame feet.

The invention can solve the ordinary persons' unpleasant feeling during making stool, it can save labour than ordinary squatting type toilets, can reduce the accumulation of toxins in the body and the occurrence of intestinal diseases. Meanwhile, the communication between the foot trample body fat scale and mobile terminals is realized with bluetooth connection technology, the health data of the person who is using the toilet are fully displayed on the mobile terminal for the user's inspection of his/her health condition, thereby to reduce the risk of illness and medical burden, and even to for the larger health data for the use of the medical institutions or government agencies.

Below, the embodiments are described in detail in cooperation with the drawings to make easily understood the technical contents, characteristics and accomplishments of the present invention.

### BRIEF DESCRIPTION OF THE DRAWINGS

FIG. 1 is a structure schematic diagram of an embodiment of the invention.

FIG. 2 is a side view of the application case of the invention.

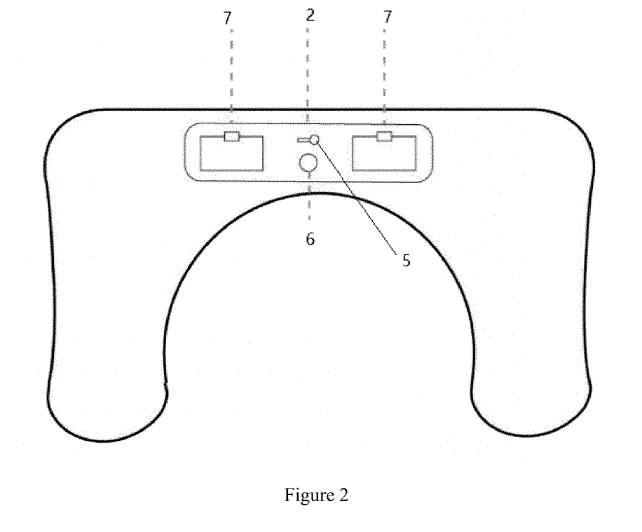

### DETAILED DESCRIPTION OF THE INVENTION

In order to make the purpose and merits of the invention clearer, the invention is further specified by combining the application case. It should be understood, wherein the specific embodiment described is just used to explain the invention, not intended to limit the invention.

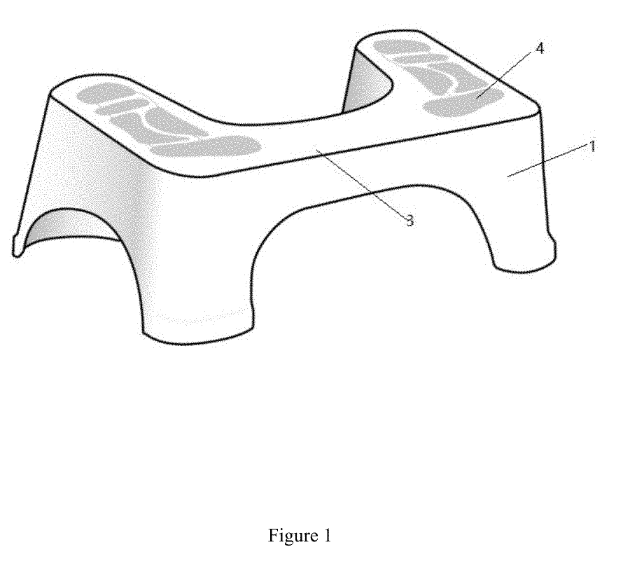

FIG. 1 shows a body fat scale on the foot stool of closestool, which includes the integrated foot stool of closestool 1 and the control board 2 of the body fat scale inserted in the foot stool of closestool 1. The is an ITO coating 4 on the top surface of the foot stool of closestool, the ITO coating 4 is set on a glassy layer 3 through electroplating, this glassy layer 3 is installed over the foot stool of closestool 1, there are many pressure sensors between the glassy layer 3 and the top surface of the foot stool of closestool 1, there are non-slip mats on the back surface of the four corners at the lower end of the foot stool of closestool 1, and both the ITO coating 4 and the pressure sensors are electrically connected with the control board 2 of the body fat scale; there is a cell box electrically connected with the control board 2 of the body fat scale, a KG/LB/ST selector switch 5 and a button switch 6 on the side face of the foot stool of closestool 1.

It is noteworthy that the material of the foot stool of closestool is prepared with 80% PP (polypropylene, a kind of thermoplastic resin)+20% calcium carbonate.

It is noteworthy that the non-slip mat is made of 100% TPE (thermoplastic elastomer material).

It is noteworthy that the control board control board 2 of the body fat scale is equipped with a bluetooth module and it can communicate with the mobile terminals through the bluetooth signals.

It is noteworthy that the control board 2 of the body fat scale is equipped with an LED display module which is horizontally inserted in and flushes with the top surface of the foot stool of closestool 1.

It is noteworthy that the number of the ITO coating 4 is 10, each five is a group and they are laid according to the model of the frame feet.

The specific implementation is completed by following the procedures below: Opening the mould according to the drawing—injection molding—installing the mainboard (including the circuit board, backlight sheet, sensors, etc.)—silk printing glass (including LOGO, patterns. etc.)—electroplating ITO—assemble the glass and pedestal together—install the silicone non-slip mats on the sole—marking the weight—second marking to confirm the accuracy of the scale—quality inspection—labeling CE marks—wipe the scale—packaging—shipment.

The ITO coating is very thin in the specific application, this coating can conduct electricity to the body when the feet stamp on it, and then a series of body data can be measured, it can record 10 groups of data of 12 persons in total and the data include “fat, moisture, visceral fat, muscle content, bone content, BMR, BMI, weight, protein and body age”. When the bluetooth signals of the bluetooth module communicate with the mobile terminals, the related data can be measured after inputting gender, age and height.

During the use of the specific application, this body fat scale can be automatically connected to the mobile terminal to measure various data after a person's stamp on it, it can shut off within 10 s after the feet move away, the mobile terminal will always record the data for this time, if there is any other person wanting to measure the data, it only needs to relieve the binding, the body fat scale will shut off within 10 s and the bluetooth signal will also shut off, so that it does not waste electricity. The body fat scale can start to measure the data as long as the weight bearing by it exceeds 1 KG and it can restart and measure the data when a person stamps on it.

The embodiments described above are only to exemplify the present invention but not to limit the scope of the present invention. Therefore, any equivalent modification or variation according to the shapes, structures, features, or spirit disclosed by the present invention is to be also included within the scope of the present invention.

What is claimed is:

1. A body fat scale on a foot stool of closestool includes an integrated foot stool of closestool and a control board of the body fat scale inserted in the foot stool of closestool, featuring that there is an ITO coating on a top surface of the foot stool of closestool, the ITO coating is set on a glassy layer through electroplating, this glassy layer is installed over the foot stool of closestool, there are many pressure sensors between the glassy layer and the top surface of the foot stool of closestool, there are non-slip mats on a back surface of four corners at a lower end of the foot stool of closestool, and both the ITO coating and the pressure sensors are electrically connected with the control board of the body fat scale; there is a cell box electrically connected with the control board of the body fat scale, a KG/LB/ST selector switch and a button switch on a side face of the foot stool of closestool.

2. The body fat scale on the foot stool of closestool according to claim 1, wherein a material of the foot stool of closestool is prepared with 80% PP+20% calcium carbonate.

3. The body fat scale on the foot stool of closestool according to claim 1, wherein the non-slip mat is made of 100% TPE material.

4. The body fat scale on the foot stool of closestool according to claim 1, wherein the control board of the body fat scale is equipped with a bluetooth module, so that it communicates with mobile terminals through bluetooth signals.

5. The body fat scale on the foot stool of closestool according to claim 1, wherein the control board of the body fat scale is equipped with an LED display module which is horizontally inserted in and flush with the top surface of the foot stool of closestool.

6. The body fat scale on the foot stool of closestool according to claim 1, wherein number of the ITO coating is 10, each five is a group and they are laid according to a model of a frame feet.
